(19) United States
(12) Patent Application Publication
(10) Pub. No.: US 2004/0009888 A1
(43) Pub. Date: Jan. 15, 2004

(54) Detergent compositions

(75) Inventors: Peter William Appel, Vlaardingen (NL); Aliaksei Kalbasenka, Rijswijk (NL); Lammert Nauta, Vlaardingen (NL); Peter Iwan Stuut, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/454,570

(22) Filed: Jun. 4, 2003

(30) Foreign Application Priority Data
Jun. 11, 2002 (EP) 02077269.5

(51) Int. Cl. C11D 17/00

(52) U.S. Cl. 510/446; 510/447

(57) ABSTRACT

A cleaning tablet which has a plurality of discrete regions with differing compositions, characterised in that at least one first region of the tablet is a smooth region and at least one second region of the tablet is a solid region and wherein the concentration of surfactants in said first region is at least 5 times the concentration of surfactants in said second region.

This invention relates to cleaning compositions in the form of tablets for use in fabric washing or machine dishwashing.

Detergent compositions in tablet form have advantages over powdered products in that they do not require measuring and are thus easier to handle and dispense into the washload.

Tablets of a cleaning composition are generally made by compressing or compacting a quantity of the composition in particulate form.

Tablets comprising two or more separate regions have also been described. For example WO 01/42416 describes the production of multi-phase moulded bodies comprising a combination of core moulded bodies and a particulate premix. WO 00/61717 describes a detergent tablet which is characterised in that at least part of its outer surface is semi-solid. WO 00/04129 describes a multi-phase detergent tablet comprising a first phase in the form of a shaped body having at least one mould therein and a second phase in the form of a particulate solid compressed within said mould. WO 99/24549 describes a detergent tablet comprising a compressed solid body and a non-compressed gelatinous portion mounted in a mold of said body.

There have been a number of proposals for tablets which are subdivided into separate regions (e.g. layers) which differ in their composition.

WO 99/35225 relates to moulded bodies with two solid phases wherein one phase of no more than 40 vol % of the moulded body contains more than 80 wt % of the total of an active substance contained in the moulded body with an ingredient from the group of surfactants.

The present invention aims to provide a multi-phase cleaning tablet with good dispersing properties, which allows a wide range of formulations and which can easily be prepared at low cost.

According to the present invention there is provided a cleaning tablet which has a plurality of discrete regions with differing compositions, characterised in that at least one first region of the tablet is a smooth region and at least one second region of the tablet is a solid region and wherein the concentration of surfactants in said first region is at least 5 times the concentration of surfactants in said second region and wherein said tablet comprises non-soap anionic surfactants and nonionic surfactants in a weight ratio of from 10:1 to 1:10.

The regions of the tablet are possibly separate layers within a tablet. However, a discrete region of a tablet could also have other forms for example one or more core(s) or insert(s). Preferably the first region has a weight of from 2 to 20 grammes, more preferred from 3 to 10 grammes. Preferably the second region has a weight of 10 to 50 grammes, more preferred 15 to 30 grammes.

The first region of the tablet is a smooth region. For the purpose of this invention the term smooth phase refers to compositions which are on the one hand solid enough to retain their shape at ambient temperature and on the other hand smooth in appearance. Smooth textures are generally of low or no porosity and have—at normal viewing distance—the appearance of a continuous phase for example as opposed to porous and particulate appearance of a compacted particulate material.

W099/24549 describes the use of non-compressed gelatinous portions mounted in a mold as a smooth phase. These tablets must be made with specific equipment to ensure the appropriate mold formation. Furthermore the compositions for the smooth phase as disclosed in this document contain very high levels of ingredients with a limited functionality in the wash such as dipropylennglycolbutylether or glyceroltriacetate.

WO 00/61717 describes (in the example) the preparation of a compressed particulate tablet on top of which a (non-compressed) layer was made by pouring a mixture of nonionic and PEG followed by hardening. This formulation and its method of preparation is disadvantageous because it requires a very long hardening step in the tablet mould, during which the tablet mould cannot be used for further production, therewith significantly increasing the cost of production.

Preferably the smooth region of the tablet is a semi-solid region. For the purpose of this invention the term semi-solid refers to compositions which are one the one hand solid enough to retain their shape at ambient temperature but which are neither completely solid.

A suitable test to check if a composition can be considered as semi-solid can be described with reference to the accompanying drawings which diagrammatically illustrate the testing of a cylindrical tablet:

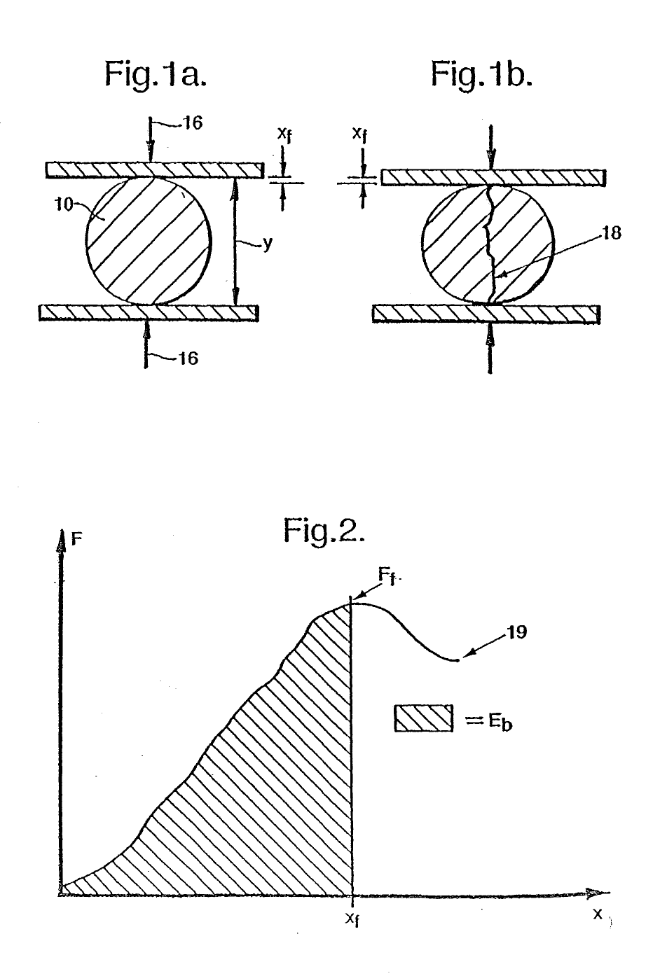

FIG. 1a shows a tablet when first contacted by the platens of an Instron testing machine,

FIG. 1b shows the tablet at the point of failure,

FIG. 2 diagrammatically illustrates the form of a graph obtained during testing.

A cylindrical tablet 10 with a diameter of 45 mm and a height of 20 mm is compressed radially between the plates 12, 14 of a material testing machine until the tablet fractures. At the starting position shown in FIG. 1a, the plates 12, 14 contact the tablet but do not apply force to it. Force is applied, as indicated by the arrows 16 to compress the tablet, the vertical speed of the upper plate is 25 mm/minute. The testing machine measures the applied force (F), and also the displacement (x) of the plates towards each other as the tablet is compressed. The distance (y) between the plates before force is applied, which is the diameter of the tablet, is also known. At failure, illustrated in FIG. 1b the tablet cracks (eg as shown at 18) and the applied force needed to maintain the displacement drops. Measurement is discontinued when the applied force needed to maintain the displacement has dropped by 25% from its maximum value as indicated 19 in FIG. 2. The displacement at failure (x_{f}) is indicated between FIGS. 1a and 1b.

A graph of force (F) against displacement (x) has the form illustrated by FIG. 2. The maximum force is the force at failure (F_{f}). The break energy is the area under the graph of force against displacement, up to the point of break. It is shown shaded in FIG. 2 and is given by the equation:

$${E}_{b} = {\int }_{0 - {x}_{f}} F ( x ) ⅆ x$$

wherein E_{b} is the break energy in mjoules, x is the displacement in metres and F is the applied force in Newtons at displacement x and X_{f} is the displacement at failure.

Semi-solid compositions are characterised by a ratio of F_{f} to E_{b} of less than 1.0, more preferred from 0.1 to 0.9, most preferred from 0.2 to 0.6, while traditional tablets of compacted particulate materials are generally characterised by a ratio of F_{f} to E_{b} of more than 1, more generally more than 1.25 or even more than 1.5 up to say 6.

In an advantageous embodiment of the invention said first region comprises from 40-100 wt % of surfactants (based on the total weight of the first region), more preferred from 50-95 wt %, most preferred the first region is predominantly constituted by surfactants e.g. more than 60% for example 70 to 90 wt %. It has been found that the combination of a separate smooth or semi-solid first region and these high surfactant levels provide very good dispersing and cleaning properties to the tablet.

Preferably the surfactants in the first region comprise a combination of non-soap anionic surfactants and non-ionic surfactants in a weight ratio of from 5:1 to 1:5, more preferred 3:1 to 1:3, more preferred 2:1 to 1:2. Further surfactants, for example cationic surfactants may equally be present for example at a level of 0.1 to 10 wt % based on the weight of the smooth or semi-solid part. Also advantageously the smooth or semi-solid region may comprise soap for example at a level of 0.1 to 10 wt % based on the weight of the smooth or semi-solid part.

Also advantageously the smooth or semi-solid region of the tablet may comprise diluent materials for example polyethyleneglycol or (mono-)propyleneglycol. Preferable the level of these diluents is from 0 to 40 wt %, more preferred 2 to 30, most preferred 10-25 wt % based on the weight of the smooth or semi-solid region.

The smooth or semi-solid phase preferably comprises no or only low levels of water. Preferably the level of water is less than 20 wt % based on the weight of the semi-solid phase, more preferred less than 15 wt %, most preferred from 5 to 12 wt %. Most preferably the semi-solid phases are substantially free from water, which means that apart from low levels of moisture (e.g. for neutralisation or as crystal water) no additional added water is present.

Preferably the total weight of surfactants in the first region is from 2 to 20 grammes, more preferred from 3 to 10 grammes.

In a preferred embodiment of the invention the second region comprises no or only low levels of surfactants. Preferably the level of surfactants in the second region is less than 10 wt %(based on the total weight of the second region), more preferred from 0 to 9 wt %, most preferred from 1 to 8 wt %.

The second region of the tablet is a solid region, for example this can be prepared by compression or melting. Preferably the second region is a compacted particulate composition.

The second region preferably comprises ingredients of the tablet other than surfactants. Examples of these ingredients are builders, bleach system, enzymes etc. Preferably the builders in the tablet are predominantly present in the second region. Preferably the bleach system is predominantly present in the second region. Preferably the enzymes are predominantly present in the second region. For the purpose of this invention the term “predominantly present” refers to a situation wherein at least 90 wt % of an ingredient is present in the second region, more preferred more than 98 wt %, most preferred substantially 100 wt %.

The above description of the tablet has been given with reference to a tablet constituted by two regions. It will however be understood that each of the regions may be composed of a limited number of discrete regions. For example the first smooth or semi-solid region may be a single discrete part of the tablet but may also be a limited number (say 1-5) discrete smooth or semi-solid parts. Preferably each of these smooth or semi-solid parts are at least 1 gramme, also preferably each of these smooth or semi-solid parts is substantially of the same composition. If reference is made to the composition or weight of the first region it is understood that this concerns the total weight and composition of these smooth or semi-solid parts.

Similarly the solid second region may be composed of a limited number (say 1-5) of solid parts e.g. separate layers in the tablet. Preferably each of these parts has a weight of at least 10 grammes, also preferably each of the solid parts are substantially of the same composition. If reference is made to the composition or weight of the second region it is understood that this concerns the total weight and composition of these solid parts.

In addition to the smooth or semi-solid first region and the solid second region the cleaning tablets of the invention may optionally comprise further regions, for example the tablet may be partly or wholly coated.

Cleaning tablets according to the invention are preferably manufactured by a process comprising the steps of:

(a) inserting a particulate composition into a tablet mould;

(b) inserting one or more smooth or semi-solid parts into said tablet mould;

(c) co-compression of the composition to form a compressed tablet comprising discrete regions, wherein the first region is formed by said compressed smooth or semi-solid part(s) and the second region is formed by said compressed particulate composition.

Steps (a) and (b) can be in any order, although a preferred embodiment the particulate composition is first introduced into the tablet mould, followed by positioning of the smooth or semi-solid part(s) in said mould. Optionally the particulate composition may be flattened or pre-compressed before introducing the semi-solid part(s).

In a preferred embodiment of the invention the particulate composition is pre-compressed at a force of 0.1 to 20 kN/cm² between steps (a) and (b) In another preferred embodiment the particulate composition is flattened between steps (a) and (b).

Preferably the (co-)compression of the combination of the semi-solid and the solid region(s) takes place at a force of from 0.1 to 20 kN/cm². Especially if the solid region has been pre-compressed the co-compression in step (c) can advantageously be at a force of 0.01-10 kN/cm², more preferred 0.2 to 5 kN/cm².

If the solid region has not been pre-compressed, the co-compression preferably takes place at a force of 1-100 kN/cm²., more preferred 2-50 kN/cm²., most preferred 2-10 kN/cm².

Another preferred method for the manufacure of cleaning tablets according to the invention comprises the steps of

(a) compression of particulate composition to form a pre-compressed tablet

(b) production of a smooth or semi-solid tablet, preferably by compression of a smooth or semi-solid material

(c) assembling the final tablet by combining the pre-compressed tablet and the smooth or semi-solid tablet, preferably under the application of a co-compression force.

Preferably the pressure for preparing the pre-compressed tablet is from 0.1 to 20 kN/cm². Preferably the pressure for preparing the smooth or semi-solid tablet is preferably from 0 to 5 kN/cm², more preferred 0.01 to 5 kN/cm².

One advantage of the preferred methods of the present invention is that the co-compression step of (c) leads to good adherence of the first region to the second region and avoids the need of applying an adhesive material between the smooth or semi-solid and solid region. Another advantage of the method of the invention is that it can be carried out in a normal tablet press without the need of adaptation of the shape of the pressing surfaces.

A tablet of this invention may be intended for use in machine dishwashing. Such a tablet is likely to contain surfactant in a low concentration such as 0.5 to 2 wt % based on the whole tablet, although higher concentrations ranging up to 10 wt % may be used. Such will typically contain salts, such as over 60 wt %, often over 85 wt % of the tablet.

Water soluble salts typically used in machine dishwashing compositions are phosphates (including condensed phosphates) carbonates and silicates, generally as alkali metal salts. Water soluble alkali metal salts selected from phosphates, carbonates and silicates may provide 60 wt % or more of a dishwashing composition.

Another preferred possibility is that a tablet of this invention will be intended for fabric washing. In this event the tablet will be likely to contain at least 2 wt %, probably at least 5 wt %, up to 40 or 50 wt % surfactant based on the whole tablet, and from 5 to 80 wt % detergency builder, based on the whole tablet.

Materials which may be used in tablets of this invention will now be discussed in more detail.

Surfactant Compounds

Compositions which are used in tablets of the invention will contain one or more detergent surfactants. In a fabric washing composition, these preferably provide from 5 to 50% by weight of the overall tablet composition, more preferably from 8 or 9% by weight of the overall composition up to 40% or 50% by weight. Surfactant may be anionic (soap or non-soap), cationic, zwitterionic, amphoteric, nonionic or a combination of these.

Anionic surfactant may be present in an amount from 0.5 to 50% by weight, preferably from 2% or 4% up to 30% or 40% by weight of the tablet composition.

Synthetic (i.e. non-soap) anionic surfactants are well known to those skilled in the art. Examples include alkylbenzene sulphonates, particularly sodium linear alkylbenzene sulphonates having an alkyl chain length of C₈-C₁₅; olefin sulphonates; alkane sulphonates; dialkyl sulphosuccinates; and fatty acid ester sulphonates.

Primary alkyl sulphate having the formula

ROSO₃ M⁺

in which R is an alkyl or alkenyl chain of 8 to 18 carbon atoms especially 10 to 14 carbon atoms and M⁺ is a solubilising cation, is commercially significant as an anionic surfactant.

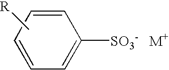

Linear alkyl benzene sulphonate of the formula where R is linear alkyl of 8 to 15 carbon atoms and M⁺ is a solubilising cation, especially sodium, is also a commercially significant anionic surfactant.

Frequently, such linear alkyl benzene sulphonate or primary alkyl sulphate of the formula above, or a mixture thereof will be the desired anionic surfactant and may provide 75 to 100 wt % of any anionic non-soap surfactant in the composition.

In some forms of this invention the amount of non-soap anionic surfactant lies in a range from 5 to 20 wt % of the tablet composition.

It may also be desirable to include one or more soaps of fatty acids. These are preferably sodium soaps derived from naturally occurring fatty acids, for example, the fatty acids from coconut oil, beef tallow, sunflower or hardened rapeseed oil.

Suitable nonionic surfactant compounds which may be used include in particular the reaction products of compounds having a hydrophobic group and a reactive hydrogen atom, for example, aliphatic alcohols, acids, amides or alkyl phenols with alkylene oxides, especially ethylene oxide.

Specific nonionic surfactant compounds are alkyl (C₈₋₂₂) phenol-ethylene oxide condensates, the condensation products of linear or branched aliphatic C₈₋₂₀ primary or secondary alcohols with ethylene oxide, and products made by condensation of ethylene oxide with the reaction products of propylene oxide and ethylene-diamine.

Especially preferred are the primary and secondary alcohol ethoxylates, especially the C₉₋₁₂ and C₁₂₋₁₅ primary and secondary alcohols ethoxylated with an average of from 5 to 20 moles of ethylene oxide per mole of alcohol.

In some fabric washing tablets of this invention, the amount of nonionic surfactant lies in a range from 4 to 40%, better 4 or 5 to 30% by weight of the whole tablet.

Many nonionic surfactants are liquids. These may be absorbed onto particles of the composition.

In a machine dishwashing tablet the surfactant may be wholly nonionic, in an amount below 5 wt % of the whole tablet although it is known to include some anionic surfactant and to use up to 10 wt % surfactant in total.

Detergency Builder

A composition which is used in tablets of the invention will contain from 5 to 80%, more usually 15 to 60% by weight of detergency builder. This may be provided wholly by water soluble materials, or may be provided in large part or even entirely by water-insoluble material with water-softening properties. Water-insoluble detergency builder may be present as 5 to 80 wt %, better 5 to 60 wt % of the composition.

Alkali metal aluminosilicates are strongly favoured as environmentally acceptable water-insoluble builders for fabric washing. Alkali metal (preferably sodium) aluminosilicates may be either crystalline or amorphous or mixtures thereof, having the general formula:

0.8−1.5 Na₂O.Al₂O₃.0.8−6 SiO₂.xH₂O

These materials contain some bound water (indicated as “xH2O”) and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature.

Suitable crystalline sodium aluminosilicate ion-exchange detergency builders are described, for example, in GB 1429143 (Procter & Gamble). The preferred sodium aluminosilicates of this type are the well known commercially available zeolites A and X, the novel zeolite P described and claimed in EP 384070 (Unilever) and mixtures thereof.

Conceivably a water-insoluble detergency builder could be a layered sodium silicate as described in U.S. Pat. No. 4664839. NaSKS-6 is the trademark for a crystalline layered silicate marketed by Hoechst (commonly abbreviated as “SKS-6”). NaSKS-6 has the delta-Na₂SiO₅ morphology form of layered silicate. It can be prepared by methods such as described in DE-A-3,417,649 and DE-A-3,742,043. Other such layered silicates, such as those having the general formula NaMSiₓO₂ₓ₊₁.yH₂O wherein M is sodium or hydrogen, x is a number from 1.9 to 4, preferably 2, and y is a number from 0 to 20, preferably 0 can be used.

Water-soluble phosphorous-containing inorganic detergency builders, include the alkali-metal orthophosphates, metaphosphates, pyrophosphates and polyphosphates. Specific examples of inorganic phosphate builders include sodium and potassium tripolyphosphates, orthophosphates and hexametaphosphates.

Non-phosphorous water-soluble builders may be organic or inorganic. Inorganic builders that may be present include alkali metal (generally sodium) carbonate; while organic builders include polycarboxylate polymers, such as polyacrylates, acrylic/maleic copolymers, and acrylic phosphonates, monomeric polycarboxylates such as citrates, gluconates, oxydisuccinates, glycerol mono- di- and trisuccinates, carboxymethyloxysuccinates, carboxymethyloxymalonates, dipicolinates and hydroxyethyliminodiacetates.

At least one region (preferably the second region) of a fabric washing tablet preferably include polycarboxylate polymers, more especially polyacrylates and acrylic/maleic copolymers which can function as builders and also inhibit unwanted deposition onto fabric from the wash liquor.

Bleach System

Tablets according to the invention may contain a bleach system in at least one region of a tablet, preferably in the second region. This preferably comprises one or more peroxy bleach compounds, for example, inorganic persalts or organic peroxyacids, which may be employed in conjunction with activators to improve bleaching action at low wash temperatures. If any peroxygen compound is present, the amount is likely to lie in a range from 10 to 25% by weight of the composition.

Preferred inorganic persalts are sodium perborate monohydrate and tetrahydrate, and sodium percarbonate, advantageously employed together with an activator. Bleach activators, also referred to as bleach precursors, have been widely disclosed in the art. Preferred examples include peracetic acid precursors, for example, tetraacetylethylene diamine (TAED), now in widespread commercial use in conjunction with sodium perborate; and perbenzoic acid precursors. The quaternary ammonium and phosphonium bleach activators disclosed in U.S. Pat No. 4,751,015 and U.S. Pat. No. 4,818,426 (Lever Brothers Company) are also of interest. Another type of bleach activator which may be used, but which is not a bleach precursor, is a transition metal catalyst as disclosed in EP-A-458397, EP-A-458398 and EP-A-549272. A bleach system may also include a bleach stabiliser (heavy metal sequestrant) such as ethylenediamine tetramethylene phosphonate and diethylenetriamine pentamethylene phosphonate.

As indicated above, if a bleach is present and is a water-soluble inorganic peroxygen bleach, the amount may well be from 10% to 25% by weight of the composition.

Other Detergent Ingredients

The detergent tablets of the invention may also contain (preferably in the second region) one of the detergency enzymes well known in the art for their ability to degrade and aid in the removal of various soils and stains. Suitable enzymes include the various proteases, cellulases, lipases, amylases, and mixtures thereof, which are designed to remove a variety of soils and stains from fabrics. Examples of suitable proteases are Maxatase (Trade Mark), as supplied by Gist-Brocades N.V., Delft, Holland, and Alcalase (Trade Mark), and Savinase (Trade Mark), as supplied by Novo Industri A/S, Copenhagen, Denmark. Detergency enzymes are commonly employed in the form of granules or marumes, optionally with a protective coating, in amount of from about 0.1% to about 3.0% by weight of the composition; and these granules or marumes present no problems with respect to compaction to form a tablet.

The detergent tablets of the invention may also contain (preferably in the second region) a fluorescer (optical brightener), for example, Tinopal (Trade Mark) DMS or Tinopal CBS available from Ciba-Geigy AG, Basel, Switzerland. Tinopal DMS is disodium 4,4′bis-(2-morpholino-4-anilino-s-triazin-6-ylamino) stilbene disulphonate; and Tinopal CBS is disodium 2,2′-bis-(phenyl-styryl) disulphonate.

An antifoam material is advantageously included (preferably in the second region), especially if a detergent tablet is primarily intended for use in front-loading drum-type automatic washing machines. Suitable antifoam materials are usually in granular form, such as those described in EP 266863A (Unilever). Such antifoam granules typically comprise a mixture of silicone oil, petroleum jelly, hydrophobic silica and alkyl phosphate as antifoam active material, absorbed onto a porous absorbed water-soluble carbonate-based inorganic carrier material. Antifoam granules may be present in an amount up to 5% by weight of the composition.

It may also be desirable that a detergent tablet of the invention includes an amount of an alkali metal silicate, particularly sodium ortho-, meta- or disilicate. The presence of such alkali metal silicates at levels, for example, of 0.1 to 10 wt %, may be advantageous in providing protection against the corrosion of metal parts in washing machines, besides providing some measure of building and giving processing benefits in manufacture of the particulate material which is compacted into tablets.

A tablet for fabric washing will generally not contain more than 15 wt % silicate. A tablet for machine dishwashing will often contain more than 20 wt % silicate. Preferably the silicate is present in the second region of the tablet.

Further ingredients which can optionally be employed in a region of a fabric washing detergent of the invention tablet (preferably the second region) include anti-redeposition agents such as sodium carboxymethylcellulose, straight-chain polyvinyl pyrrolidone and the cellulose ethers such as methyl cellulose and ethyl hydroxyethyl cellulose, fabric-softening agents; heavy metal sequestrants such as EDTA; perfumes; and colorants or coloured speckles.

Further ingredients which can optionally be used in tablets of the invention, preferably in the second region are dispersing aids. Examples of suitable dispersing aids are water-swellable polymers (e.g. SCMC) highly soluble materials (e.g. sodium citrate, potassium carbonate or sodium acetate) or sodium tripolyphospate with preferably at least 40% of the anhydrous phase I form.

Particle Size and Distribution

The second region of a detergent tablet of this invention, is a preferably a matrix of compacted particles.

Preferably the particulate composition has an average particle size in the range from 200 to 2000 μm, more preferably from 250 to 1400 μm. Fine particles, smaller than 180 μm or 200 μm may be eliminated by sieving before tableting, if desired, although we have observed that this is not always essential.

While the starting particulate composition may in principle have any bulk density, the present invention is especially relevant to tablets made by compacting powders of relatively high bulk density, because of their greater tendency to exhibit disintegration and dispersion problems. Such tablets have the advantage that, as compared with a tablet derived from a low bulk density powder, a given dose of composition can be presented as a smaller tablet.

Thus the starting particulate composition may suitably have a bulk density of at least 400 g/litre, preferably at least 500 g/litre, and perhaps at least 600 g/litre.

Tableting machinery able to carry out the manufacture of tablets of the invention is known, for example suitable tablet presses are available from Fette and from Korch.

Tableting may be carried out at ambient temperature or at a temperature above ambient which may allow adequate strength to be achieved with less applied pressure during compaction. In order to carry out the tableting at a temperature which is above ambient, the particulate composition is preferably supplied to the tableting machinery at an elevated temperature. This will of course supply heat to the tableting machinery, but the machinery may be heated in some other way also.

The size of a tablet will suitably range from 10 to 160 grams, preferably from 15 to 60 g, depending on the conditions of intended use, and whether it represents a dose for an average load in a fabric washing or dishwashing machine or a fractional part of such a dose. The tablets may be of any shape. However, for ease of packaging they are preferably blocks of substantially uniform cross-section, such as cylinders or cuboids. The overall density of a tablet preferably lies in a range from 1040 or 1050 gm/litre up to 1600 gm/litre.

### EXAMPLE 1

A detergent powder was made of the following composition by pregranulating the granule ingredients, followed by post-dosing the rest of the ingredients

| Ingredient | Parts by weight |
|---|---|
| granules | |
| Na-las | 1.1 |
| Nonionic 7EO | 0.5 |
| Soap (C16-C18) | 0.1 |
| Zeolite A24 | 2.4 |
| NaAc3aq | 0.3 |
| Light soda ash | 0.4 |
| SCMC (68%) | 0.1 |
| Moisture/minors | 0.4 |
| Post-dose | |
| EAG (17% silicone) | 3.0 |
| Fluorescer (15%) | 2.2 |
| STP HPA | 28.3 |
| STP LV | 34.0 |
| Na-disilicate (80%) | 3.8 |
| TAED (83%) | 4.3 |
| Percarbonate | 16.9 |
| Dequest 2047 | 1.9 |
| Minors/enzymes/colour | to 100 |

Smooth or semi-solid parts were prepared of the following composition:

| Ingredient | Parts by weight |
|---|---|
| Na-las | 39.1 |
| Nonionic 7EO | 33.5 |
| C12 soap | 7.3 |
| Monopropyleenglycol | to 100 |

The mixture was heated to 80° C. and cast into moulds and cooled to 20° C. to form firm, 5 grammes smooth and semi-solid parts of 32 mm diameter and 6 mm high.

The tablets were made in 2 different ways:

(I) 25 grammes of the powder are inserted into a 45 mm die of a tabletting machine, optionally followed by a flattening step, followed by addition of a single smooth and semi-solid part on top of the powder bed. After addition of the smooth and semi-solid part onto the powder bed or flattened powder, the whole material is compressed at 6 kN/cm² into a single tablet, followed by ejection of the tablet. This results in a tablet with a smooth and semi-solid part embedded in the cleaning tablet. The height of the smooth or semi-solid part after compression is 3.4 mm, of the powdered part 11 mm.

(II) Another way of making a tablet with compressed phase and a smooth and semi-solid part is to put a single smooth and semi-solid part as above onto 25 grammes of the (optionally pre-compressed at 4 kN/cm²) powdered composition in a die of 45 mm diameter followed by a final compression step at 0.8 kN/cm². During the final compression step, the smooth and semi-solid part flows by the compaction forces to form a 3.4 mm smooth semi-solid layer adhered on top of the particulate layer. The height of the powdered part after compression is 11 mm.

Tablets prepared according the above methods provide good adherence of the smooth or semi-solid part to the rest of the tablet therewith avoiding the need to use adhesive materials. Furthermore the tablets of the invention show fast dispersing of the compacted powder region during the washing process therewith allowing the early release of e.g. builder components into the washing liquor. The compressed semi-solid part shows delayed dispersing therewith providing the surfactants at a later stage during the washing process.

1. A cleaning tablet which has a plurality of discrete regions with differing compositions, characterised in that at least one first region of the tablet is a smooth region and at least one second region of the tablet is a solid region and wherein the concentration of surfactants in said first region is at least 5 times the concentration of surfactants in said second region and wherein said tablet comprises non-soap anionic surfactants and nonionic surfactants in a weight ratio of from 10:1 to 1:10.

2. A tablet according to claim 1, wherein the smooth region is a semi-solid region.

3. A tablet according to claim 1 wherein the smooth or semi-solid region comprises from 50-100 wt % of surfactants.

4. A tablet according to one or more of claim 1 wherein the smooth or semi-solid region of said tablet comprises non-soap anionic surfactants and nonionic surfactants in a weight ratio of from 5:1 to 1:5, more preferred from 3:1 to 1:3.

5. A tablet according to claim 2 wherein the semi-solid region has ratio of F_{f} (in N) to E_{b} (in mJ)—as measured on a tablet of 45 mm diameter and 20 mm height—of less than 1.0, more preferred 0.1 to 0.9, most preferred 0.2 to 0.6.

6. A tablet according to claim 1, wherein the second region comprises less than 10 wt % of surfactants.

7. A tablet according to any one of claims 1, wherein the second region is a compacted particulate region.

8. A tablet according to any one of claims 1, wherein the first region is a compressed smooth or semi-solid layer and the second region is a layer of compacted particulate material.

9. Method to prepare a cleaning tablet according to one or more of claim 1 comprising the steps of:
(a) inserting a particulate composition into a tablet mould;
(b) inserting one or more smooth or semi-solid parts into said tablet mould;
(c) co-compression of the particulate composition and the smooth or semi-solid parts to form a compressed tablet comprising discrete regions, wherein the first region is formed by said compressed smooth or semi-solid parts and the second region is formed by said compressed particulate composition.

10. Use of a cleaning tablet according to claim 1 as a fabric washing detergent.
